(19) United States
(12) Patent Application Publication
(10) Pub. No.: US 2012/0067177 A1
(43) Pub. Date: Mar. 22, 2012

(54) Multi-functional jaw wrench combined with self adjusting socket

(76) Inventor: Paul Sang Yu, Tehachapi, CA (US)

(21) Appl. No.: 12/924,229

(22) Filed: Sep. 22, 2010

(51) Int. Cl. B25B 13/46; B25B 13/06; B25B 13/28

(52) U.S. Cl. 81/60; 81/100; 81/121.1; 81/125.1

(57) ABSTRACT

A multi-functional jaw wrench combined with self adjusting socket is provided. The multi-functional jaw wrench is comprised of one fixed jaw and one movable jaw at the first end of the handle and a self-adjustable socket that is rotatably attached on the second end of the handle. The self-adjustable socket comprises of many small diameter pins arranged inside of a bore surrounding a six phased rod placed at the center of the bore. The self-adjustable socket is rotatably engaged to a circular gears developed inside of a hole of a socket receiver that is developed on the second end of the handle via a socket head section. Another embodiment of the current invention of the self-adjustable socket receiver can be folded ±90 degrees to align the socket with the handle and enables a user reach a bolts located inside of a structure.

### FIELD OF THE INVENTION

The present invention relates to a combined socket wrench, especially, to a self-adjusting wrench combined with self-forming socket that adjusts to nuts and bolt heads of different sizes and shapes.

### BACKGROUND OF THE INVENTION

In these days so many machines are assembled with many bolts, nuts, wing-nuts, screws, and similar fasteners of different shape and sizes. To handle such variety of fasteners, a large variety of fastening tools are developed. Even for a standard hex-head bolt, there are numerous inch and metric sizes. So, even for a well experienced craftsman, in order to be fully prepared to work with such a myriad of bolts, he must maintain a large assortment of socket sizes, and sometimes that assortment must include different socket shapes. In addition to this, if the head of the fastener is rounded and has gears around the head, the craftsman needs a jaw wrench. Therefore socket wrench and fastener are needed at the same time in many cases. However, according to limit of the current products, the craftsman has to locate the correct size socket-head and switches between different sized socket-heads to use in conjunction with a wrench or power tool . . . . It is not only time consuming, cumbersome and un-comfortable tasks for the craftsman, but also unproductive for the employer who hired the craftsman. It is purpose of the current invention to provide a wrench that can perform the jaw wrench's and socket wrench's function at the same time without changing the tool.

### DESCRIPTION OF THE PRIOR ART

U.S. Pat. No. 7,721,628 to Lorger, et al. illustrates a manually or mechanically/hydraulically operable tong of light weight and high load capacity by means of a multi-layer interlocking construction achieved by cutting the shapes from plate steel by known means, assembling the plate sections in suitable order, and retained with each other by cylindrical steel pins (8) forming a multi hinged tool capable of engaging the job circumference on two or more points equally via replaceable jaw dies (15) retained radially and axially.

U.S. Pat. No. 7,628,383 to Cumbers illustrates a ratchet strap tightener and a power driven rotary tool are arranged to be operated together for tightening a strap. The body of the power driven rotary tool is arranged to be anchored in mating engagement relative to the body of the ratchet strap tightener, in addition to coupling the rotating mating parts of the tool and the strap tightener, such that the torque applied when winding the spindle of the tightener no longer acts to twist the tightener body from the user's hands but rather the torque is anchored directly through the bodies so that winding of the spindle with the power driven tool can be accomplished quickly, efficiently and in a safe manner.

U.S. Pat. No. 6,349,621 to Khachatoorain illustrates a wrench for applying a force to a work piece comprises a handle having proximal and distal ends, top and bottom edges and a slot extending therethrough with a groove extending downward from the slot. A fixed jaw is mounted at the distal end of the handle having an inner, contact surface for contacting the work piece, and a moveable jaw is pivotally mounted at the distal end of the handle having an inner, contact surface for contacting the work piece. A spring is mounted in the handle having a distal end in contact with the moveable jaw for biasing the moveable jaw toward the fixed jaw. A slidable button is mounted on the top edge of the handle, with a spring mounted between the slidable button and the top edge of the handle. A connector is provided having a distal end fixedly attached to the moveable jaw and a proximal end fixedly attached to the slidable button by a pin. In operation, the pin rides in the slot and fits in the groove.

U.S. Pat. No. 6,314,839 to Carter illustrates a reversible ratchet wrench which includes: a support body having a head portion and a handle support portion having a cylindrically shaped section; a ratchet wheel having teeth extending around the perimeter thereof; a pawl member; a pivot member; and a rotatable handle. The pawl member, which is pivotally supported by the head portion, includes a pair of spaced apart teeth engaging members, which are alternatively engagable with the teeth on the ratchet wheel. The pivot member, pivotally supported on the support body, includes first and second ends and an intermediate pivot point. The first end includes a means for engaging the coupling means provided on the pawl member. The second end includes a means for engagement with the rotatable handle. The handle, which is rotatably supported on the cylindrically shaped section, includes a first end having recess for receiving the second end of said pivot member, whereby rotation of the handle about the cylindrically shaped section moves the pivot member about the pivot point, thereby moving the pawl member from a first position to a second position. The handle rotates relative to the cylindrically shaped section through an angle of, preferably, 40.degree.-60.degree. The first end of the handle may also include a second, longer recess for receiving the second end of the pivot member. The handle support portion is solid and integral with the head portion. Finally, the wrench includes a spring biased detent which is biased into engagement with either one or the other of two surfaces provided on the pawl member.

U.S. Pat. No. 5,622,090 to Marks illustrates a self-forming socket having a plurality of retractable pins bundled in parallel within a housing. The bundled pins may displace longitudinally and are biased by spring force away from a frame onto which the pins are slidably held. A spacer pin may be positioned at the center of the socket and is similarly biased away from the frame under spring force. When the socket is forced over a fastener, nut, or bolt head, groups of pins are pushed inward toward the frame and into the housing thereby conforming the pins to the contours of the fastener.

Applying a torque to the socket transfers the torque through the bundled pins to the fastener. Each pin has a circular cross-section and an enlarged head and the interior walls of the housing containing the bundled pins has a hexagonal shape and may not contain any right angles. Grooves can be formed in the sides of the hexagonal shape to receive therein circular sides of adjacent ones of the enlarged heads. The pins are packed in a hexagonal arrangement.

U.S. Pat. No. 5,193,420 to Smith is directed to a universal wrench for use with vehicle lug nuts. A two piece housing containing a plurality of spring-biased retractable round pins is shown. The pins are spaced apart from each other to allow assembly of the tool and to allow placement of adaptor cones on the end of each pin. These round pins appear to function independently of each other since the pin distal ends are spaced from any further components in a non-contacting arrangement. Hence, the pins must transmit torque to a fastener by bending forces along their length. The pins cannot be closely packed since the pin head 25 is of a second diameter greater than a first diameter of the engaging pin 24, which is the portion which engages a fastener. The pin heads 25 must further be spaced from each other to be contained within the first housing 11.

U.S. Pat. No. 5,157,995 to Nogues discloses a multiple socket wrench comprised of several coaxially disposed socket members housed within each other. The sockets are spring loaded and each has a reduced diameter towards the outer end that prevents the abutting sockets contained therein from falling off as a result of gravity or the spring force of the different spring members associated with each one of the sockets. Each spring urges each socket outwardly, and the springs of the sockets that are smaller than the head of the bolt or screw being matched are overcome and retracted, thereby automatically matching the correct size socket to the head of the bolt or nut.

U.S. Pat. No. 4,993,288 to Anderson, et al. illustrates a power driven socket holding ratchet wrench which has a socket made so that it has a central opening that may be used for receiving a long stud or member, which passes through the socket. The wrench acts much like a box end wrench. The wrench is made so that it can be relatively compact in axial height, that is, along the length of the sprocket and the frame is small in diameter relative to the socket size to permit it to fit into tight places. The power drive is capable of being positioned at an angle relative to the wrench head, and the wrench includes a unique ratcheting and quick release mechanism that facilitates the operation of the unit.

U.S. Pat. No. 4,987,802 to Chern illustrates a power wrench includes a socket which is rotatably retained in a head portion of the wrench by a retainer. A yoke is actuated to swing by a driving axle. A number of grooves are formed in the yoke and in the retainer, each groove gradually changes from narrow to wide and receives a roller and a spring. The rollers slidably contact the socket. When the yoke rotates in one direction, the socket is actuated to rotate. When the yoke rotates in a reverse direction, the rollers in the retainer are caused to hold the socket and prevent the socket from backlash.

U.S. Pat. No. 4,887,498 to Zayat discloses a tool for form engaging and turning components such as nuts, bolts, and screws. In its basic form, the Zayat device includes a chamber which in turn supports a bundle of pins each of which is adapted to slide farther upwardly into the chamber when the lower pin end contacts the component at the lower end of the housing. Each of the pins has flat sides and sharp corners in order to engage a nut either by the flat sides or the sharp corners.

U.S. Pat. No. 3,698,267 to Denney discloses fastener actuator having a plurality of fastener engaging elements, wherein the elements are bundled and slide independently and longitudinally into and out of the actuator to accommodate a bolt head, nut, or slotted screw-head. Each element has a rectangular cross-section in order to grip the flat sides of a standard bolt head, or to fit into the flat walls of a slotted screw-head.

U.S. Pat. No. 3,695,125 to Glass, et al. illustrates an open end ratchet wrench having a laminar head structure consisting of a central body portion with a pair of side caps permanently metal bonded on opposite sides thereof, the head structure defining therein between the caps an arcuate channel within which a spring biased ratchet pawl is slidable between an extended torquing position and a retracted ratcheting position. A pawl retention detent forming a permanent part of the head structure is movable between a temporary open position permitting insertion of the pawl and its biasing spring into the otherwise completely fabricated head structure, and a permanent closed position wherein the pawl is permanently retained in the head, the detent means defining the outer limit of sliding movement of the pawl in the head. With this construction a true open end ratchet wrench can be economically fabricated of any desired tool metal with a minimum number of parts and by simple production steps; the resulting wrench having high torquing capacity, minimal head thickness, and attractive appearance, approaching these respective characteristics in a solid open end wrench of comparable size.

U.S. Pat. No. 3,349,655 to Locke discloses an adjustable tool for installing or removing fasteners of various sizes, comprising of a bundle of rods surrounded by a girdle and resiliently mounted in a chuck. The rods may be pressed into conformity with the head of a fastener, and upon the application of torque to the chuck, the girdle constricts and accordingly torque is applied to the fastener through the rods. Each of the rods has flat sides and the rods of the bundle are tightly packed.

U.S. Pat. No. 2,711,112 to Durand discloses another multiple socket wrench having coaxially aligned sockets of varying sizes organized on the ratchet in a concentric arrangement.

U.S. Pat. No. 1,529,605 to Muncey discloses a wrench having closely packed and individually extendable rods that engage a bolt head or nut. Each of the extendable pins has a rectangular shaped cross-section.

None of the prior art disclosed a multi-functional wrench that functions the jaw wrench and socket wrench at the same time as illustrated in the current invention.

### SUMMARY OF THE INVENTION

In these days so many machines are assembled with many bolts, nuts, wing-nuts, screws, and similar fasteners of different shape and sizes. To handle such variety of fasteners, a large variety of fastening tools are developed. So, even for a well experienced craftsman, in order to be fully prepared to work with such a myriad of bolts, he must maintain a large assortment of socket sizes, and sometimes that assortment must include different socket shapes. In addition to this, if the head of the fastener is rounded and has gears around the head, the craftman needs a jaw wrench. Therefore socket wrench and fastener are needed at the same time in many cases. However, according to limit of the current products, the craftsman has to locate the correct size socket-head and switches between different sized socket-heads to use in conjunction with a wrench or power tool . . . . It is not only time consuming, cumbersome and un-comfortable tasks for the craftsman, but also unproductive for the employer who hired the craftsman. It is purpose of the current invention to provide a wrench that can perform the jaw wrench's and socket wrench's function at the same time without changing the tool.

A multi-functional jaw wrench combined with self adjusting socket is provided. The multi-functional jaw wrench is comprised of; one fixed jaw and one movable jaw at the first end of the handle and a self-adjustable socket that is rotatably attached on the second end of the handle. The self-adjustable socket comprises of many small diameter pins arranged inside of a bore surrounding a six phased rod placed at the center of the bore. The self-adjustable socket is rotatably engaged to a circular gears developed inside of a hole of a socket receiver that is developed on the second end of the handle via a socket head section. Another embodiment of the current invention of the self-adjustable socket receiver can be folded 90 degrees.

### BRIEF DESCRIPTION OF THE DRAWINGS

FIG. 1 is a perspective front view of a multi-functional jaw wrench combined with self adjusting socket according to current invention.

FIG. 2 is a perspective rear view of a multi-functional jaw wrench combined with self adjusting socket according to current invention.

FIG. 3 is an exploded view of the self-adjustable socket section ‘A’ in the FIG. 1 of the multi-functional jaw wrench combined with self adjusting socket according to current invention.

FIG. 4 is a cross-sectional view of the head section of the self adjusting socket according to current invention seen from the plane ‘B’ to the direction ‘C’.

FIG. 5 is a cross-sectional view of the head of the self adjusting socket according to current invention showing the mechanism of limiting the fastening direction.

FIG. 6 is an exploded perspective view of another embodiment of the current invention showing a foldable self-adjustable socket receiver.

### DETAILED DESCRIPTION OF THE PREFERRED EMBODIMENT

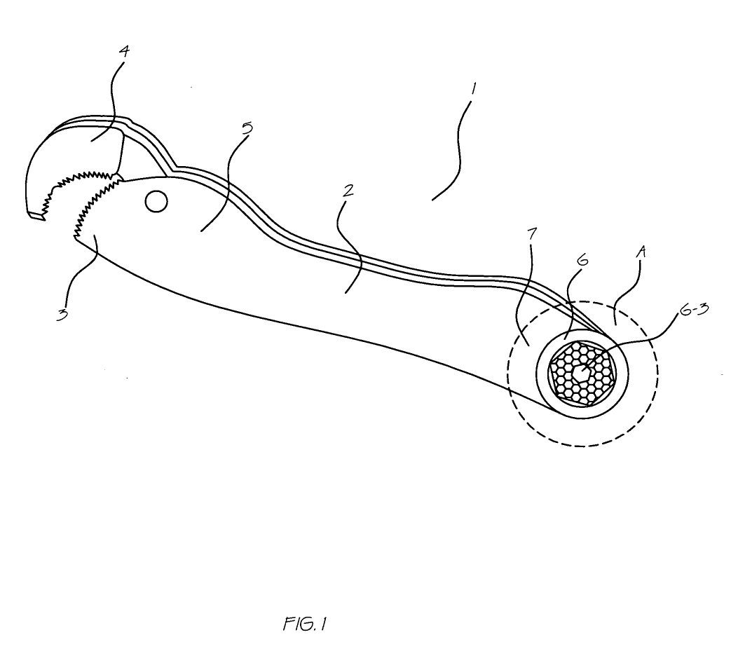

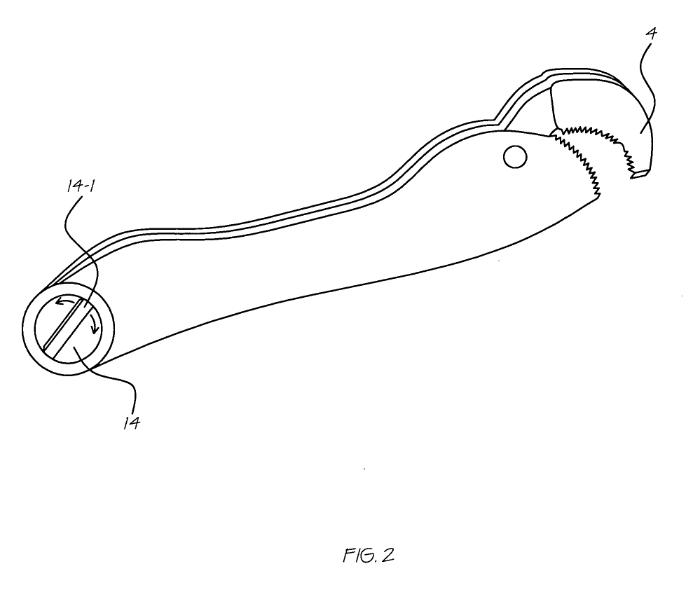

FIG. 1 and FIG. 2 is a perspective front and rear view of a multi-functional jaw wrench combined with self adjusting socket according to current invention, respectively.

The multi-functional jaw wrench (1) combined with self adjusting socket according to current invention is comprised of one handle (2). One fixed jaw (3) and one movable jaw (4) are formed at the first end (5) of the handle (2). A self-adjustable socket (6) is rotatably attached on the second end (7) of the handle (2). The self-adjustable socket (6) comprises of many small diameter pins (6-1) arranged inside of a bore (6-2) surrounding a six phased rod (6-3) placed at the center of the bore (6-2).

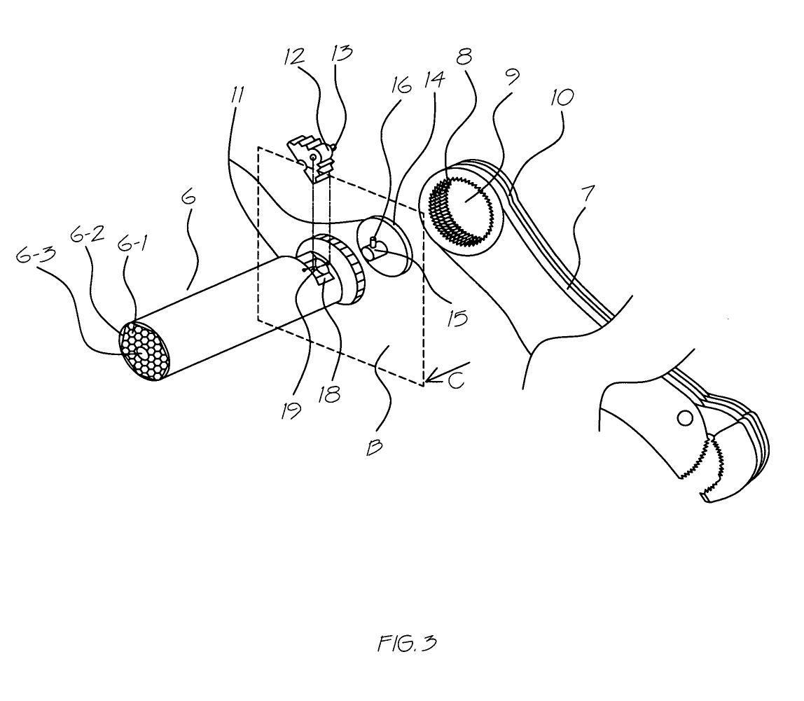

FIG. 3 is an exploded view of the self-adjustable socket (6), section ‘A’, in the FIG. 1 of the multi-functional jaw wrench (1) combined with self adjusting socket according to current invention. The self-adjustable socket (6) is rotatably engaged to a circular gear (8), which is developed inside of a hole (9) of a socket receiver (10) that is developed on the second end (7) of the handle via a socket head section (11).

The self-adjustable socket (6) has a socket head section (11) that is comprised of one rotating direction changing gear (12) which has a hole that penetrate the thickness of the gear, one gear pin (13), one gear turning knob (14), one gear turning knob shaft (15), one gear holding pin (16), and one gear holding pin supporting spring (17). A segmental circle shape groove (18) is formed at head section (11) area to receive the rotating direction changing gear (12). A segmental cylindrical groove (19) is developed at the center of the flat bottom of the segmental circle shape groove (18) to receive the gear turning knob shaft (15).

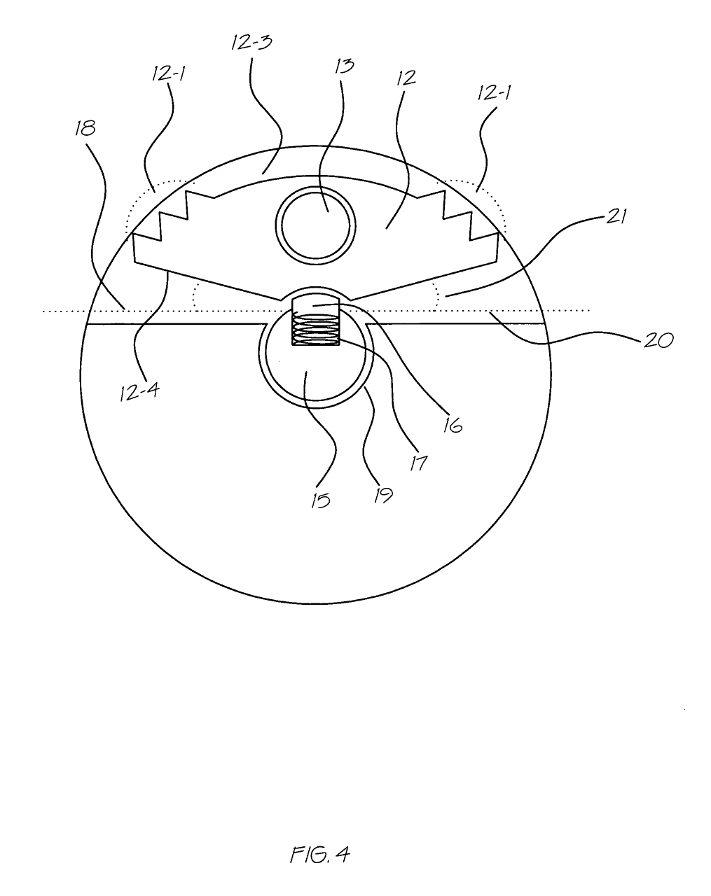

FIG. 4 is a cross-sectional view of the head section (11) of the self adjusting socket (6) according to current invention seen from the plane ‘B’ to the direction ‘C’. The rotating direction changing gear (12) is rotatably fixed inside of the segmental circle shape groove (18) via the gear pin (13). The rotating direction changing gear (12) has unique geometry as shown in the FIG. 4 to enable changing the rotating direction by single turn of the gear turning knob (14). The rotating direction changing gear (12) has two teeth wings (12-1) each of them has three teeth (12-2) developed at the wing tip. The upper surface (12-3) of the gear (12) has the same curvature of the cylindrical self adjusting socket (6) body. Lower surface (12-4) of the gear (12) is flat but each wing (12-1)'s bottom surface is tapered form an imaginary horizontal line (20) with an angle (21) larger than 2 degrees. A concave groove (22) is developed at the center of the lower surface (12-4) of the rotating direction changing gear (12) to meet the gear holding pin (16). The gear holding pin (16) is engaged inside of a pin bore (23) and supported by a spring (17) from the bottom. The other side view of the gear turning knob (14) and the knob handle (14-1) is shown in the FIG. 1.

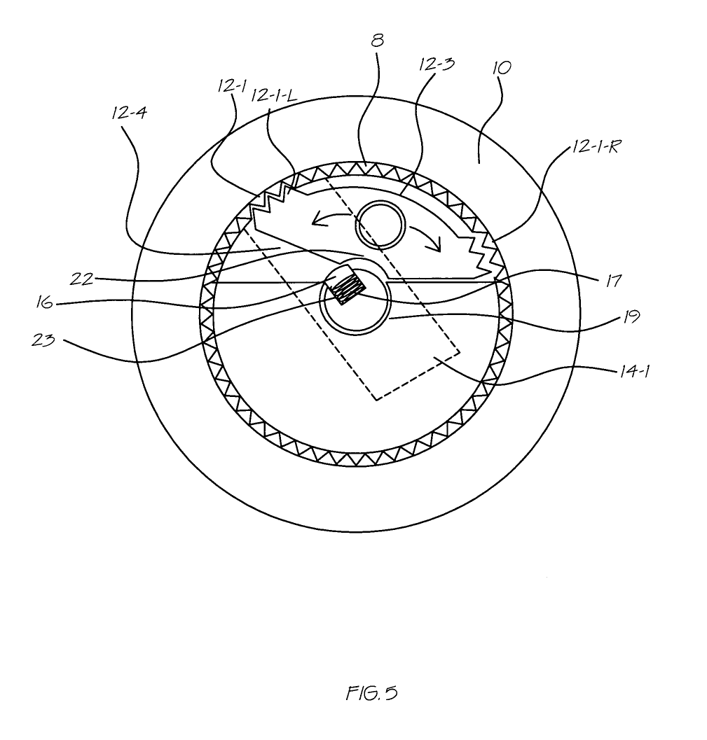

FIG. 5 is a cross-sectional view of the head of the self adjusting socket (6) according to current invention showing the mechanism of limiting the fastening direction.

When a user try to fasten a right fastening bolt with hexagonal head, turn the knob handle (14-1) of the gear turning knob (14) to the anti-clock wise direction. Then the gear holding pin (16) turns anti-clock wise along the concave groove (22) and pushed upward by the gear holding pin supporting spring (17). Then the tip of the gear holding pin (16) slides out of the concave groove (22) and push the rotating direction changing gear (12) to clock wise until the right wing (12-1-R)'s lower surface touches the flat surface of the segmental circle shape groove (18). At this moment the teeth of the left wing (12-1-L) is engaged to the circular gears (8), which are developed inside of a hole (9) of a socket receiver (10). Since the right wing (12-1-R) is blocked by the flat surface of the segmental circle shape groove (18), the right fastening bolt with hexagonal head will turn clock wise direction and fastened when a user turns the multi-functional jaw wrench (1) to the clock wise direction.

Meanwhile, when the user turns the multi-functional jaw wrench (1) to the anti-clock wise direction, the left teeth wing (12-1-L) pushes the gear holding pin (16) back to the pin bore (23) and released from the circular gears (8) to allow the user make a space to return to fastening action. By repeatedly turning the multi-functional jaw wrench (1) anti-clock wise and clock wise, the user can fasten a right fastening bolt with hexagonal head.

When a user try to loosen a right fastening bolt with hexagonal head, turn the knob handle (14-1) of the gear turning knob (14) to a clock wise direction. Then the gear holding pin (16) turns to clock wise along the concave groove (22) and pushed upward by the gear holding pin supporting spring (17). Then the tip of the gear holding pin (16) slides out of the concave groove (22) and push the rotating direction changing gear (12) to anti-clock wise direction until the left wing (12-1-L)'s lower surface touches the flat surface of the segmental circle shape groove (18). At this moment the teeth of the right wing (12-1-R) is engaged to the circular gears (8), which are developed inside of a hole (9) of a socket receiver (10). Since the left wing (12-1-L) is blocked by the flat surface of the segmental circle shape groove (18), the right fastening bolt with hexagonal head will turn anti-clock wise direction and loosened when a user turns the multi-functional jaw wrench (1) to the anti-clock wise direction.

Meanwhile, when the user turns the multi-functional jaw wrench (1) to the clock wise direction, the right wing (12-1-R) pushes the gear holding pin (16) back to the pin bore (23) and released from the circular gears (8) to allow the user make a space to return to loosening action. By repeatedly turning the multi-functional jaw wrench (1) anti-clock wise and clock wise, the user can loosen a right fastening bolt with hexagonal head.

The self adjusting socket (6) receives hexagonal headed bolt of various size. When a user finds a bolt of non-hexagonal head, he/she can loosen or fasten the bolt with the jaw wrench on the other end of the multi-functional jaw wrench (1) according to current invention without leave the place to find another jaw wrench.

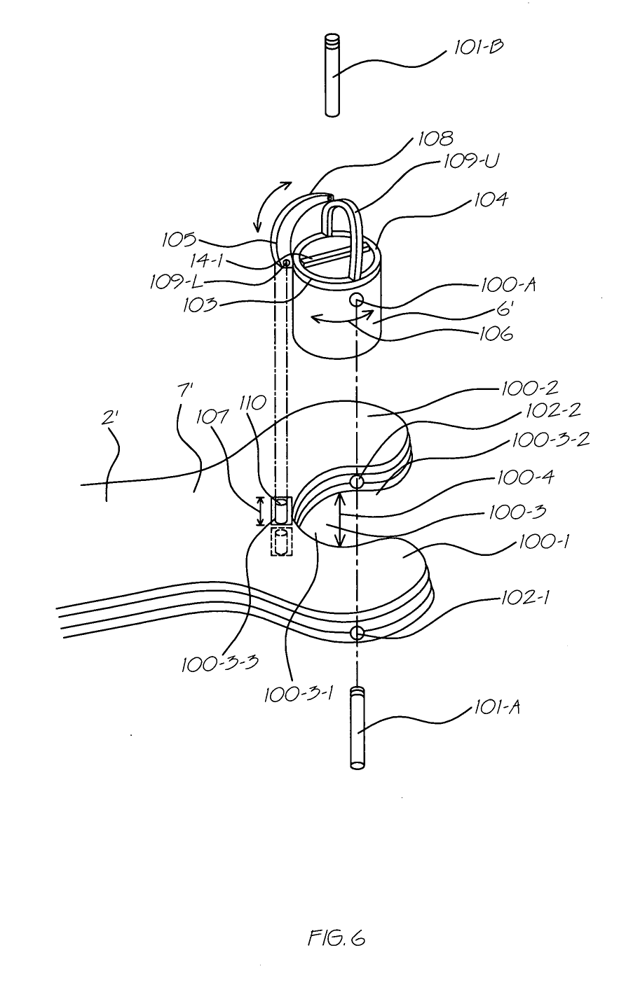

FIG. 6 is an exploded perspective view of another embodiment of the current invention showing a foldable self-adjustable socket receiver. (100). When craftsmen repair car or other machines, they often face a bolt locates deep inside of many barriers other parts. Then the first embodiment of the multi-functional jaw wrench (1) according to current invention can not reach the bolts locating deep inside. Then, the craftsman needs an adaptor or a connector to reach the bolts. However, if the self-adjustable socket receiver can be folded 90 degrees, the craftsman can reach bolts deep inside. The second embodiment of the multi-functional jaw wrench has a foldable self-adjustable socket receiver (100). To rotatably hold the foldable self-adjustable socket receiver (100), two arms (100-1) and (100-2) that extended from the second end (7′) of the handle (2′) and surrounds the foldable self-adjustable socket receiver (100). Between the two arms (100-1),(100-2), an arch shape groove (100-3) is formed. The arch shape groove (100-3) is comprised of one hemi-circle groove (100-3-1) and one large square groove (100-3-2). The hemi-circular groove (100-3-1) has a diameter (100-4) which is same as the outer diameter (106) of the foldable self-adjustable socket receiver (100). The foldable self-adjustable socket receiver (100) is pivotally engaged to the two arms of (100-1) and (100-2) via pins (101-A) and (101-B) that penetrate the two arms through two pinholes of (102-1) and (102-2) and engaged to the foldable self-adjustable socket receiver (100) through another pin hole (100-A) and (100-B), which are developed on the foldable self-adjustable socket receiver (100). The two pinholes of (102-1) and (102-2), which are developed on the two arms (100-1) and (100-2) respectively, are located slightly away from point where the center line of the hemi-circular groove (100-3-1) and the large square groove (100-3-2) meets to the large square groove (100-3-2) direction.

One half-ring shaped guide rail (103) is vertically welded on the foldable self-adjustable socket receiver (100). The half-ring shaped guide rail (103)'s outer diameter is the same as that of the foldable self-adjustable socket receiver (100). The half-ring shaped guide rail (103) aligned with the direction of the pins (101-A) and (101-B).

One end of a quarter-ring shaped guide rail (105) is welded over the top of the half-ring shaped guide rail (103) and the other end is welded on the upper outer-round surface of the self-adjustable socket receiver (100). Another small square groove (100-3-3) is developed on the top of the hemi-circular groove (100-3-1) opposite to the large square groove (100-3-2). The width (107) of the small square groove (100-3-3) is same as the thickness (108) of the quarter-ring shaped guide rail (105). Two pairs of dents, lower dents (109-L) and upper dents (109-U), are formed on the surface of the quarter-ring shaped guide rail (105) to receive two stopping pins (110) located inside of the small square groove (100-3-3).

When a craftsman fastens a nut on an outer surface of a machine, the lower dents (109-L) are engaged by the two stopping pins (110). Then the gear turning knob guide (104) aligned with the surface of the handle (2′). The overall shape looks the same as the first embodiment of the current invention shown in the FIGS. 1 and 2.

To fasten a bolt locates deep inside of a narrow space, turn the foldable self-adjustable socket receiver (100) 90 degrees around the pin (101). Then the lower dents (109-L) are released from the two stopping pins (110) and the upper dents (109-U) are engaged. Then the foldable self-adjustable socket receiver (100) aligned with the handle (2′) to allow access into the narrow space:

What is claimed is:

1. A multi-functional jaw wrench combined with self adjusting socket is comprised of;
one handle,
and
one fixed jaw and one movable jaw which are formed at the first end of the handle,
and
a self-adjustable socket, which comprises of many small diameter pins arranged inside of a bore surrounding a six phased rod placed at the center of the bore
and
is rotatably engaged to a circular gears, which are developed inside of a hole of a socket receiver that is developed on the second end of the handle via a socket head section;
which has segmental circle shape groove formed at head section area to receive the rotating direction changing gear
and
a segmental cylindrical groove developed at the center of the flat bottom of the segmental circle shape groove to receive a gear turning knob shaft,
and
is comprised of;
one rotating direction changing gear that has
two teeth wings each of them has three teeth developed at the wing tip and
has one upper surface having the same curvature of the cylindrical self adjusting socket body and
has one lower surface flat but each wing's bottom surface is tapered form an imaginary horizontal line with an angle of 2 degrees and
has concave groove developed at the center of the lower surface thereof to meet a gear holding pin and
has a hole that penetrate the thickness of the gear and is rotatably fixed inside of the segmental circle shape groove via a gear pin,
and
one gear pin,
and
one gear turning knob,
and
one gear turning knob shaft,
and
one gear holding pin, which is engaged inside of a pin bore f\developed on the gear turning knob shaft and is supported by a spring from the bottom,
and
one gear holding pin supporting spring installed inside of a bore developed on the gear turning knob shaft.

2. A multi-functional jaw wrench combined with self adjusting socket is comprised of;
one handle, which has two arms extended from the second end thereof to form an arch shape groove that is comprised of one hemi-circle groove, whose diameter is the same as the outer diameter of a foldable self-adjustable socket receiver and has a small square groove developed on the top thereof, and one large square groove,
and
one fixed jaw and one movable jaw which are formed at the first end of the handle,
and
a self-adjustable socket, which comprises of many small diameter pins arranged inside of a bore surrounding a six phased rod placed at the center of the bore
and
is rotatably engaged to a circular gears, which are developed inside of a hole of a socket receiver that is developed on the second end of the handle via a socket head section;
which has segmental circle shape groove formed at head section area to receive the rotating direction changing gear
and
a segmental cylindrical groove developed at the center of the flat bottom of the segmental circle shape groove to receive a gear turning knob shaft,
and
is comprised of
one rotating direction changing gear that has
two teeth wings each of them has three teeth developed at the wing tip and
has one upper surface having the same curvature of the cylindrical self adjusting socket body and
has one lower surface flat but each wing's bottom surface is tapered form an imaginary horizontal line with an angle of 2 degrees and
has concave groove developed at the center of the lower surface thereof to meet a gear holding pin and
has a hole that penetrate the thickness of the gear and is rotatably fixed inside of the segmental circle shape groove via a gear pin,
and
one gear pin,
and
one gear turning knob,
and
one gear turning knob shaft,
and
one gear holding pin, which is engaged inside of a pin bore f\developed on the gear turning knob shaft and is supported by a spring from the bottom,
and
one gear holding pin supporting spring installed inside of a bore developed on the gear turning knob shaft,
and
one self-adjustable socket receiver, which is pivotally engaged to the two arms of the second end of the handle via pins, which penetrate the two arms through two pinholes and engaged to the foldable self-adjustable socket receiver through another pin holes developed on the foldable self-adjustable socket receiver
and
equipped with one half-ring shaped guide rail, which has an outer diameter that is the same as that of the foldable self-adjustable socket receiver, and is vertically welded thereon aligned with the direction of the pins
and
one quarter-ring shaped guide rail, one end of which is welded over the top of the half-ring shaped guide rail and the other end is welded on the upper outer-round surface of the self-adjustable socket receiver
and
has two pairs of dents, lower dents and upper dents, which are formed on the surface of the quarter-ring shaped guide rail to receive two stopping pins located inside of the small square groove.

3. A multi-functional jaw wrench combined with self adjusting socket of the claim 1 and claim 2, wherein the angle between tapered bottom surface and the imaginary horizontal line is 10 degrees.
